(19) United States
(12) Patent Application Publication
(10) Pub. No.: US 2025/0262745 A1
(43) Pub. Date: Aug. 21, 2025

(54) TRUSS ASSEMBLY TABLE RETROFIT ASSEMBLY

(71) Applicant: Illinois Tool Works Inc., Glenview, IL (US)

(72) Inventors: Ronald E. Findley, Arlington, TX (US); Mathew N. Milton, Carrollton, TX (US)

(21) Appl. No.: 19/050,763

(22) Filed: Feb. 11, 2025

Related U.S. Application Data
(60) Provisional application No. 63/555,674, filed on Feb. 20, 2024.

(51) Int. Cl. B25H 1/02

(52) U.S. Cl. CPC B25H 1/02

(57) ABSTRACT

A truss assembly table retrofit assembly that includes and a new drive rod actuation assembly that is configured to be attached to a drive rod of a puck assembly such that each puck assembly includes a puck, a drive rod, a drive rod support, and the drive rod actuation assembly. Such puck assemblies can be installed on new truss assembly tables. Such puck assemblies can also be retrofitted on existing truss assembly tables. For retrofitting various existing truss assembly tables, the drive rod actuation assembly includes an indirect coupling between the new servo motor and the drive rod. This indirect coupling enables the new servo motor (and the new control system) to physically fit in such an existing truss assembly table. The drive rod actuation assembly also enables the new control system to be used with the retrofit existing truss assembly table.

### PRIORITY CLAIM

This application claims priority and the benefit of U.S. Provisional Patent Application No. 63/555,674, filed Feb. 20, 2024, the entire contents of which are incorporated herein by reference.

### BACKGROUND

Wooden trusses are widely used throughout the construction industry. Wooden trusses are often built from conventional dimensional lumber members (such as what is commonly known as: a 2 by 4; a 2 by 6; a 2 by 8; etc.). The wooden members that are used to build a wooden truss are sometimes called truss members in general with the most common truss member types sometimes called chord members and web members. Such chord members extend longitudinally along the length of the truss and such web members extend transversely to the length of the truss such as along the width of the truss. A wooden truss is often built from numerous wooden truss members and metal connectors. The metal connectors are used to attach the truss members to build the wooden truss. Wooden trusses are often prefabricated in a factory and then shipped to a construction site where the wooden trusses are used to construct part of the structure of a building (such as a house or commercial facility). Buildings constructed with such prefabricated wooden roof trusses are often more economical and faster to construct than buildings constructed with conventional stick framed structures.

Various truss assembly tables have been developed and commercialized. Various such truss assembly tables include multiple puck assemblies. Each of the puck assembles includes: (1) a drive rod positioned below the top surface of the tabletop of the truss assembly table; (2) a drive rod actuation assembly directly coupled to the drive rod and positioned below the top surface of the tabletop of the truss assembly table; (3) a mounting block movably connected to the drive rod and positioned below the top surface of the tabletop of the truss assembly table; and (4) a puck connected to the mounting block, partially positioned above the top surface of the tabletop of the truss assembly table, and partially extending through a transverse vertically extending opening in the tabletop and connected to the mounting block.

The drive rod actuation assembly is configured to directly rotate the drive rod in opposite first and second rotational directions, wherein: (i) rotation of the drive rod in the first rotational direction causes the mounting block and the puck attached to the mounting block to move transversely relative to the top surface of the tabletop of the truss assembly table toward a first side of the truss assembly table; and (ii) rotation of the drive rod in the second rotational direction causes the mounting block and the puck attached to the mounting block to move transversely relative to the top surface of the tabletop of the truss assembly table toward an opposite second side of the truss assembly table.

As new truss assembly tables have been developed, new drive rod actuation assemblies have been developed. Each such new drive rod actuation assembly includes a new servo motor directly connected to the drive rod. The new servo motor is controlled by a new control system that is configured to operated differently (such as with additional functions and features) than the controllers for the various existing truss assembly tables.

It is desired to employ the servo motor and the new control system (with such additional functions and features) with such existing truss assembly tables. In other words, it is desirable to retrofit such existing truss assembly tables with such new servo motors and new control systems.

One issue that has arisen with retrofitting various existing truss assembly tables is that the new servo motor does not physically fit in the position of the previously existing drive rod actuation assembly. Thus, such new directly connectable servo motors (and the new control systems) cannot be installed on such existing truss assembly tables as a retrofit. There is a need to address this issue.

### SUMMARY

Various embodiments of the present disclosure provide a truss assembly table retrofit assembly that includes a drive rod actuation assembly that is configured to be coupled to a drive rod of a puck assembly of a truss assembly table such that the puck assembly includes: (1) a puck; (2) a mounting block; (3) a drive rod; (4) a drive rod support; and (5) the drive rod actuation assembly. The drive rod actuation assembly (and the entire puck assembly) can also be included in new truss assembly tables.

In various embodiments, for retrofitting an existing truss assembly table, the drive rod actuation assembly includes an indirect coupling between the new servo motor of the drive rod actuation assembly and the drive rod. This indirect coupling enables the new servo motor to physically fit in the space available for such existing truss assembly tables. The drive rod actuation assembly also thus enables new control systems to be used with such retrofitted existing truss assembly tables.

In various embodiments, the present disclosure only requires a change to the control system in the direction of rotation of the drive shaft of the servo motor for this retrofit based on the indirect coupling between the servo motor of the drive rod actuation assembly and the drive rod of the puck assembly.

Additional features and advantages of the present disclosure are described in, and will be apparent from, the following Detailed Description and the Figures.

### BRIEF DESCRIPTION OF THE FIGURES

FIG. 1 is a fragmentary top perspective view of part of a truss assembly table showing a puck assembly thereof in accordance with one example embodiment of the present disclosure.

FIG. 2 is an enlarged perspective view of the puck assembly of the truss assembly table of FIG. 1, shown removed from the truss assembly table.

FIG. 3 is an enlarged fragmentary perspective view of the puck assembly of the truss assembly table of FIG. 1.

FIG. 4 is an enlarged outer end view of the puck assembly of the truss assembly table of FIG. 1.

FIG. 5 is an enlarged fragmentary inner perspective view of the puck assembly of the truss assembly table of FIG. 1.

FIG. 6 is an enlarged fragmentary partially exploded perspective view of the puck assembly of the truss assembly table of FIG. 1, shown with the cover thereof removed.

FIG. 7 is an enlarged fragmentary partially exploded perspective view of the puck assembly of the truss assembly table of FIG. 1.

FIG. 8 is an enlarged fragmentary partially exploded perspective view of the puck assembly of the truss assembly table of FIG. 1.

FIG. 9 is an enlarged fragmentary exploded perspective view of the puck assembly of the truss assembly table of FIG. 1.

FIG. 10 is an enlarged fragmentary bottom perspective view of the puck assembly of the truss assembly table of FIG. 1, shown mounted to a tabletop and shown with the cover being partially transparent.

FIG. 11 is an enlarged fragmentary bottom perspective view of the puck assembly of the truss assembly table of FIG. 1, shown mounted to a tabletop and shown with the cover being partially transparent.

FIG. 12 is an enlarged fragmentary partially cross-sectional and partially perspective view of the puck assembly of the truss assembly table of FIG. 1, and shown with the cover being partially transparent.

FIG. 13 is an enlarged bottom fragmentary perspective view of the puck assembly of the truss assembly table of FIG. 1, shown mounted to a tabletop and shown with the cover being partially transparent.

FIG. 14 is an enlarged outer side perspective view of a mount of the puck assembly of the truss assembly table of FIG. 1.

FIG. 15 is an enlarged inner side perspective view of the mount of the puck assembly of the truss assembly table of FIG. 1.

### DETAILED DESCRIPTION OF EXAMPLE EMBODIMENTS

While the systems, devices, and methods described herein may be embodied in various forms, the drawings show, and the specification describes certain exemplary and non-limiting embodiments. Not all components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as mounted, connected, etc., are not intended to be limited to direct mounting methods but should be interpreted broadly to include indirect and operably mounted, connected, and like mounting methods. This specification is intended to be taken as a whole and interpreted in accordance with the principles of the present disclosure and as understood by one of ordinary skill in the art.

The present disclosure relates to truss assembly tables and particularly provides a truss assembly table with one or more spaced-apart puck assemblies.

The present disclosure also relates to a puck assembly for a truss assembly table.

The present disclosure also relates to a drive rod actuation assembly for a puck assembly for a truss assembly table.

The present disclosure also relates to a drive rod actuation assembly for a puck assembly for a truss assembly table wherein the drive rod actuation assembly is configured to be indirectly coupled to a drive rod of a puck assembly of the truss assembly table.

The present disclosure also relates to a drive rod actuation assembly that can be installed on a new truss assembly table.

The present disclosure also relates to a drive rod actuation assembly that can be installed on an existing truss assembly table where space for the drive rod actuation assembly is limited (i.e., retrofitted on an existing truss assembly table).

The present disclosure also relates to a drive rod actuation assembly that can be installed on an existing truss assembly table and also enables the new control system to be used with the retrofitted existing truss assembly table.

The present disclosure also relates to a control system that is changed in causing the rotational direction of the drive shaft of the new servo motor for the retrofit (as further explained below).

An example embodiment of a truss assembly table including a puck assembly of the present disclosure is discussed below; however, it should be appreciated that the present disclosure is not limited to the illustrated example truss assembly table or the example puck assembly described herein.

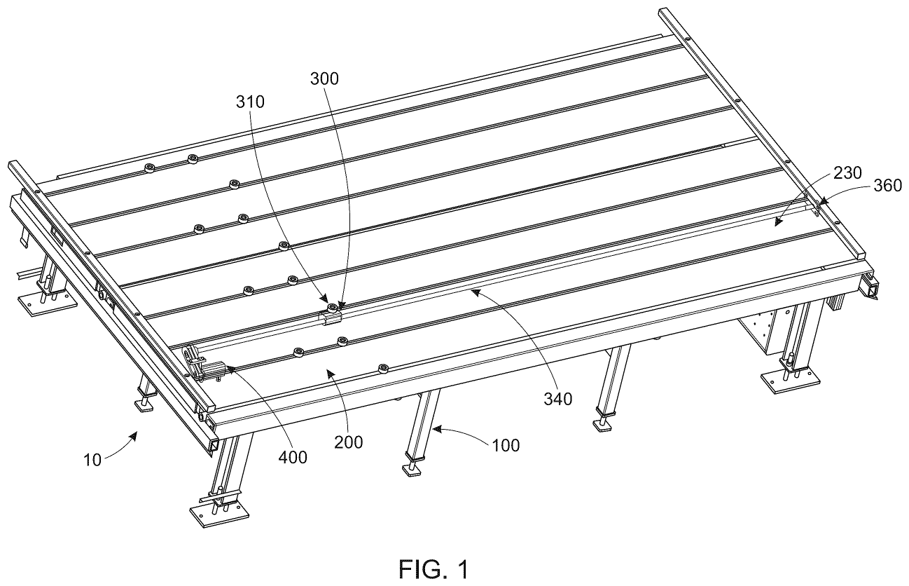

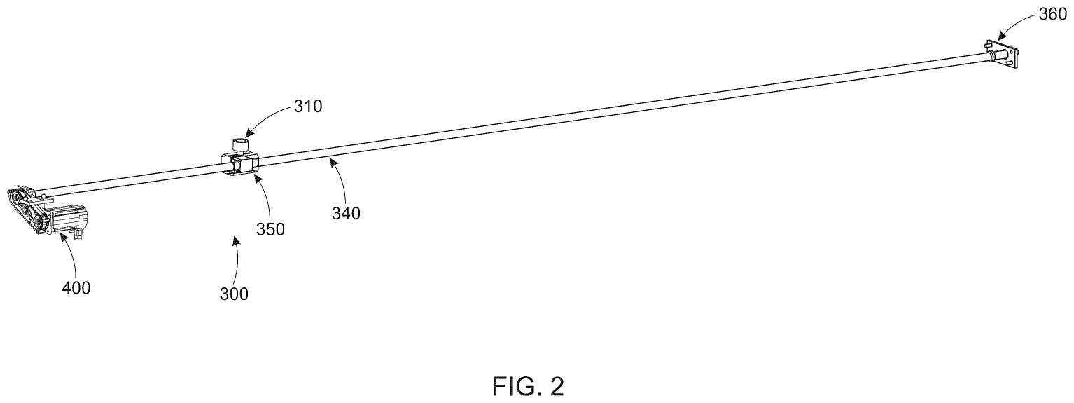

FIGS. 1 and 2 show part of a truss assembly table 10 of one example embodiment of the present disclosure. This truss assembly table 10 generally includes: (1) a table frame 100; (2) a tabletop 200; (3) spaced apart puck assemblies such as puck assembly 300; (4) a movable gantry (not shown); (5) a control system (not shown); (6) an operator interface (not shown); and (7) a power supply (not shown). For brevity, various components of the truss assembly table 10 of the present disclosure are not shown and/or described herein because such components are well known in the truss assembly table industry.

This truss assembly table 10 is configured for building a truss (not shown) on the tabletop 200 of truss assembly table 10 in an end-to-end manner on the tabletop 200.

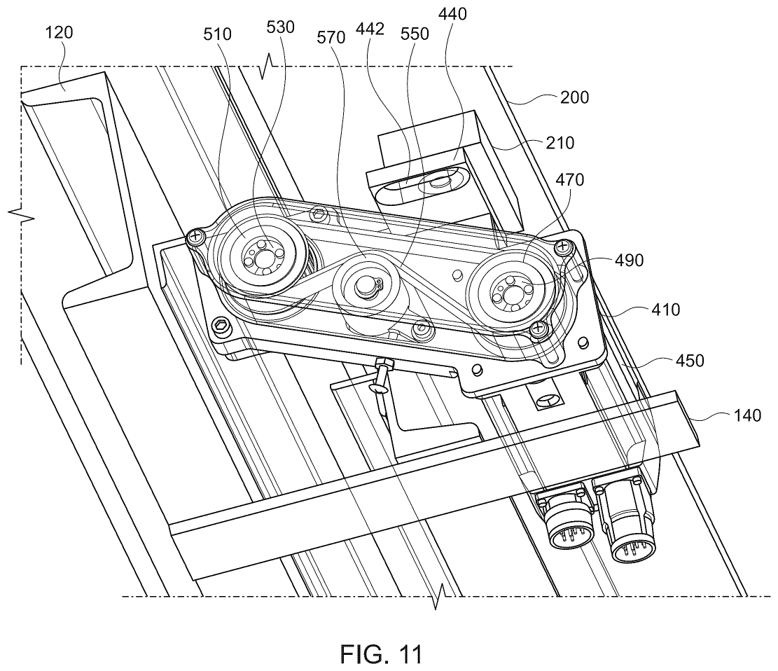

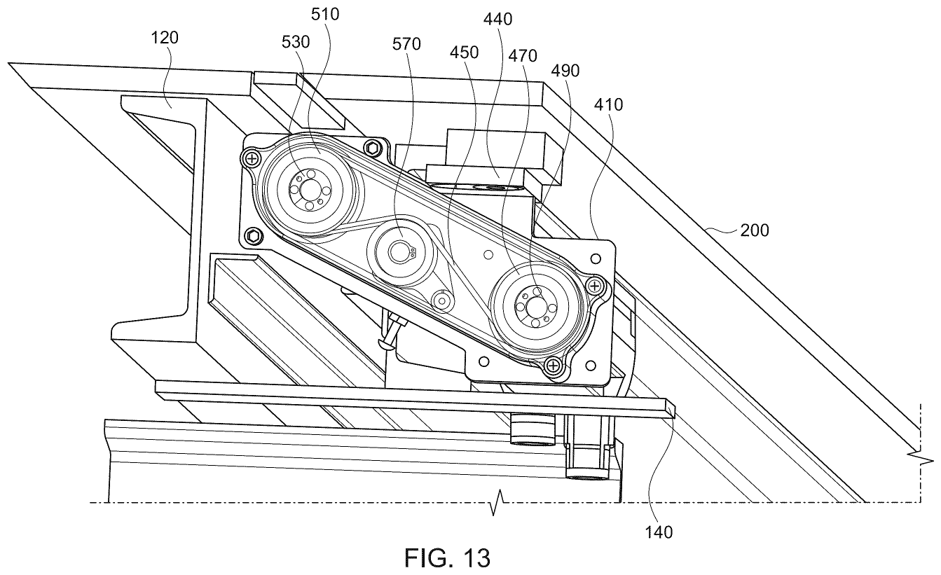

More specifically, the table frame 100 includes a plurality of frame components (not individually labeled) that are configured and attached in a suitable manner to support the various components of the truss assembly table 10. These frame components can take any suitable shape, can be formed is any suitable manner, and can be formed from any suitable materials. The table frame 100 has a longitudinal length that is longer than any truss to be built on the truss assembly table 10. The table frame 100 has a transverse width that is wider than the width of any truss to be built on the truss assembly table 10. FIGS. 1, 10, 11, 12, and 13 partly show the limited space in which a puck assembly and a drive rod actuation assembly thereof (as described below) can be installed on the table frame 100. In this example embodiment, the table frame 100 includes various structural members such as members 120 and 140.

The tabletop 200 is supported by the table frame 100, has a longitudinal length that is longer than any truss to be built on the truss assembly table 10, and has a transverse width that is wider than the width of any truss to be built on the truss assembly table 10. The tabletop 200 includes one or more horizontally extending members (not labeled), wherein the upper most member includes an upper build surface 230 on which a truss being built on the truss assembly table 10 can rest. The tabletop 200 can be formed is any suitable manner and can be formed from any suitable materials. In this example embodiment, the tabletop 100 includes various structural members under the top surface 230 such as member 210.

The truss assembly table 10, the table frame 100, and the table top 200 can be formed from multiple tables that are placed in line and connected (such as by welding) to make the full truss table assembly 10. The full truss table assembly can be made up of multiple of these individual tables which is partially shown in FIG. 1.

The multiple puck assemblies of the truss assembly table 10 are all identical in this example embodiment, and thus for brevity, only the example puck assembly 300 is shown and described herein in detail.

The example puck assembly 300 includes: (1) a moveable puck 310 partially positioned above the tabletop 200 and partially extending through the tabletop 200; (2) a rotatable drive rod 340 supported by the table frame 100 below the tabletop 200; (3) a mounting block 350 movably mounted on the rotatable drive rod 340 and supporting the puck 310; (4) a drive rod support 360 supported by the table frame 100 below the tabletop 200; and (5) a drive rod actuation assembly 400 supported by the table frame 100 below the tabletop 200. The puck 310 is movably connected to the drive rod 340 by the mounting block 330. In other embodiments that are not shown, the puck assembly 300 includes multiple pucks and multiple mounting blocks moveably mounted on the rotatable drive rod 340. Although not shown, the puck assembly 300 can include one or more vibration dampeners (that are sometimes referred to as “duck rudders”) that dampen vibrations in the drive rod 340 as the drive rod 340 rotates.

The drive rod 340 is rotatably supported at a first end by the drive rod support 360, and at the opposite second end by the drive rod actuation assembly 400. The drive rod support 360 is mounted to the tabletop 200 and configured to support the first end of the drive rod 340 such that the drive rod 340 is freely rotatable with respect to the drive rod support 360.

The drive rod actuation assembly 400 is controlled by the control system and is configured to, under control of the control system, cause the drive rod 340 rotate a first rotational direction to move the mounting block 350 and the puck 310 connected thereto toward the drive rod actuation assembly 400. The drive rod actuation assembly 400 is also configured, under control of the control system, to cause the drive rod 340 to rotate in an opposite second rotational direction to move the mounting block 350 and the puck 310 connected thereto away from the drive rod actuation assembly 400. The control system is thus able to control the rotation of the drive rod 340 and in turn the position of the mounting block 350 and puck 310 based the desired position of the puck 310 for the assembly of a respective truss being built on the tabletop 200. In other words, for each different truss built on the tabletop 200, the puck 310 can be suitable positioned to engage and hold in position a component of the truss during the building process.

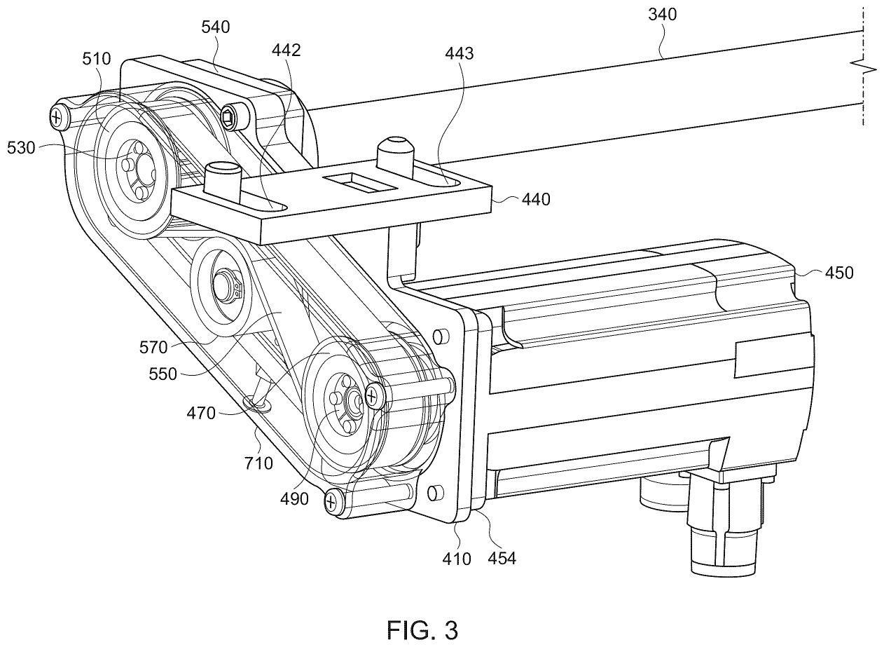

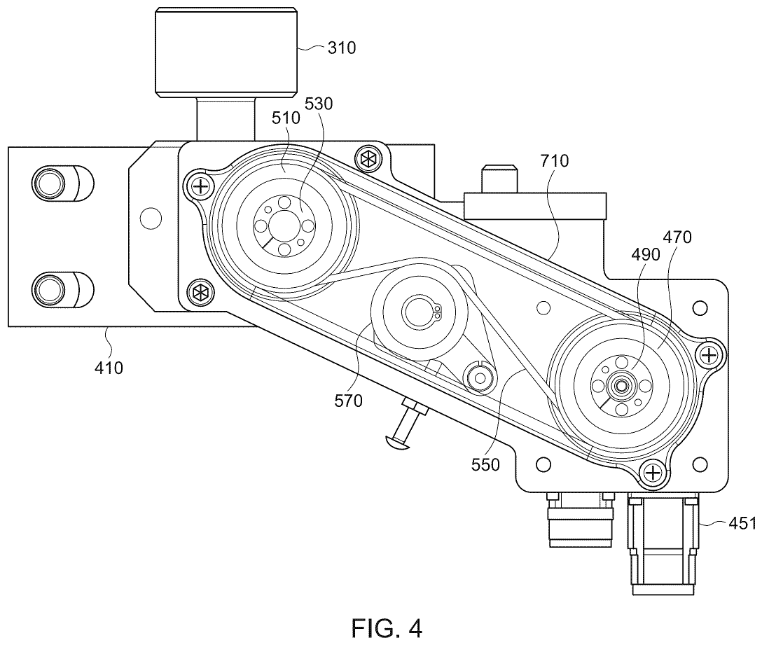

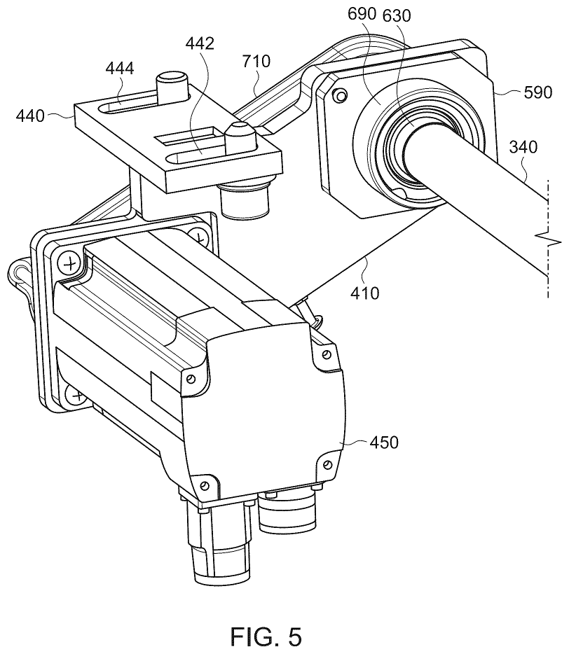

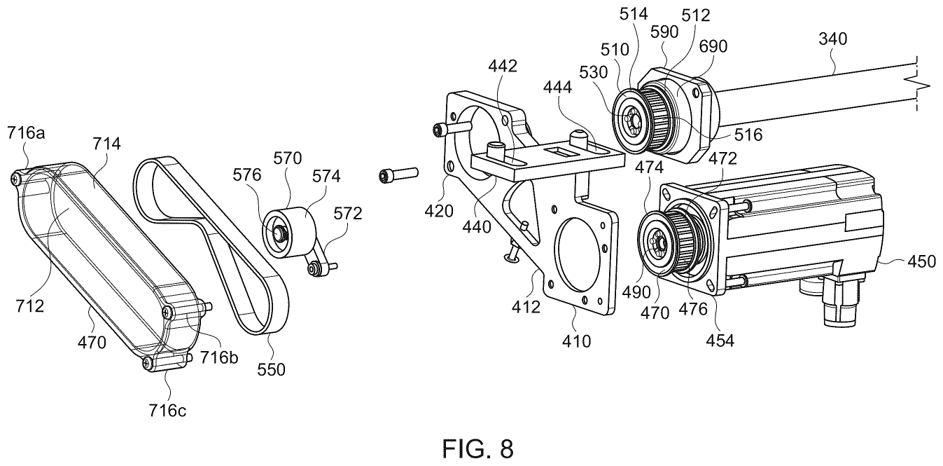

More specifically, as further shown in FIGS. 3 to 15, in this example embodiment, the drive rod actuation assembly 400 includes: (1) a mount 410; (2) a servo motor 450; (3) a first rotatable pulley 470; (4) a first locking assembly 490; (5) a second rotatable pulley 510; (6) a second locking assembly 530; (7) a drive belt 550; (8) a belt tensioner 570; (9) a connection plate 590; (10) a retainer ring 610; (11) a first bearing 630; (12) a sleeve 650; (13) a second bearing 670; (14) a bearing support sleeve 690; and (15) a cover 710.

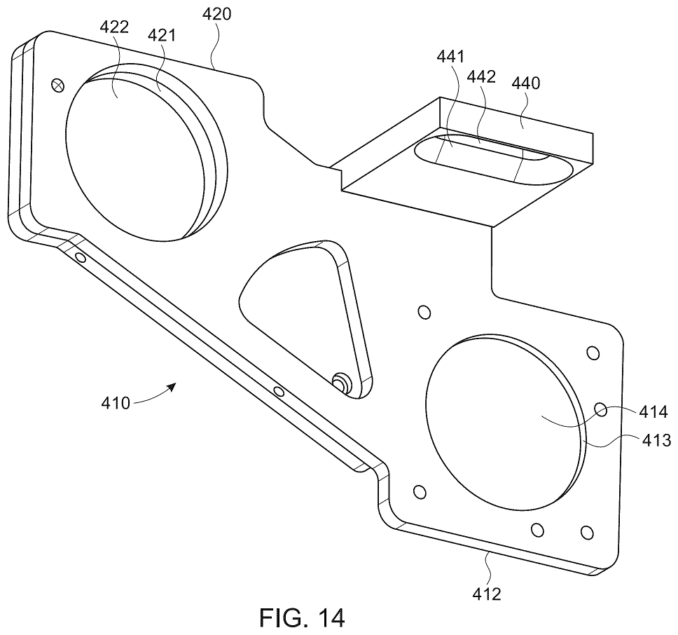

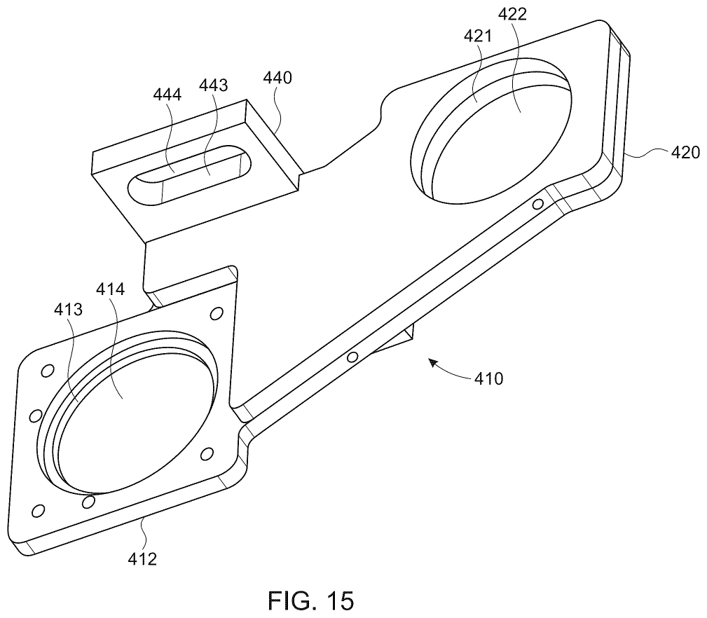

As best shown in FIGS. 14 and 15, the mount 410 includes a lower section 412, an upper section 420, and a connection section 440. In this example embodiment, the lower section 412 and the upper section 420 are formed from multiple attached (such as by welding) metal plates (such as steel plates) but can be formed in other suitable manners. The connection section 440 is a separate metal plate (such as a steel plate) in this example embodiment that is attached (such as by welding) to the lower section 412 and the upper section 420 but can be formed and connected in other suitable manners. Additionally, in other embodiments, the mount 410 can be made from other suitable materials.

As best shown in FIGS. 3, 5, 6, 11, 13, 14, and 15, the connection section 440 (that functions as a mounting plate) includes: (1) an inner surface 441 that defines an opening 442 (such as a slot) configured to receive one or more fasteners (not labeled and such as bolts) that connect the mount 410 to the table frame 100; and (2) an inner surface 443 that defines and opening 444 (such as a slot) configured to receive one or more fasteners (not labeled and such as bolts) that connect the mount 410 to the table frame 100. The connection section 440 is a single metal mounting plate in this illustrated embodiment but can be separate plates or otherwise suitably configured in other embodiments. The connection plate 440 supports the lower section 412 and the upper section 420 of the mount 410 under the tabletop 200 in the respective desired positions.

The lower section 412 is configured to be positioned a first distance from the bottom of the tabletop 200 and configured to support the servo motor 450, the first rotatable pulley 470, the first locking assembly 490, the drive belt 550, and the cover 710. The lower section 412 includes an inner surface 413 that defines an opening 414 configured to receive parts of the shaft 452 of the servo motor 450, the first rotatable pulley 470, and the first locking assembly 490.

The upper section 422 is configured to be positioned a second distance from the bottom of the tabletop 200 and configured to support the drive rod 340, the second rotatable pulley 510, the second locking assembly 530, the drive belt 550, the connection plate 590, the retainer ring 610, the first bearing 630, the sleeve 650, the second bearing 670, the bearing support sleeve 690, and the cover 710. The second distance is shorter than the first distance. The upper section 420 includes an inner surface 421 that defines an opening 422 configured to receive parts of the drive rod 340, the second rotatable pulley 510, the second locking assembly 530, the connection plate 590, the retainer ring 610, the first bearing 630, the sleeve 650, the second bearing 670, and the bearing support sleeve 690.

The servo motor 450 includes a mounting plate 454 that is mounted to the lower section 412 of the mount 410 by fasteners (not labeled). Thus, the servo motor 450 is supported by the lower section 412 of the mount 410. The fasteners also attach the cover 710 to the lower section 412 of the mount 410. The servo motor 450 is electrically connected to the control system and the power supply and is controlled by the control system. The servo motor 450 can rotate the drive shaft 452 in either rotational direction (clockwise or counterclockwise) under the control of the control system. The present disclosure contemplates that the servo motor can be any suitable actuator configured to rotate a shaft under the control of the control system. In this example embodiment, the servo motor 450: (a) is spaced-apart from the drive rod 340; and (b) extends from the mount 410 in the same direction as the drive rod 340 extends from the mount 410. In this example embodiment, the axis of rotation of the drive shaft 452 of the servo motor 450 is off set from but parallel to the axis of rotation of the drive rod 340. In this example embodiment, when the drive shaft 452 of the servo motor 450 rotates in a first rotational direction, the drive rod also rotates in the first rotational direction via the belt 550; and when the drive shaft 452 of the servo motor 450 rotates in an opposite second rotational direction, the drive rod also rotates in that second rotational direction via the belt 550.

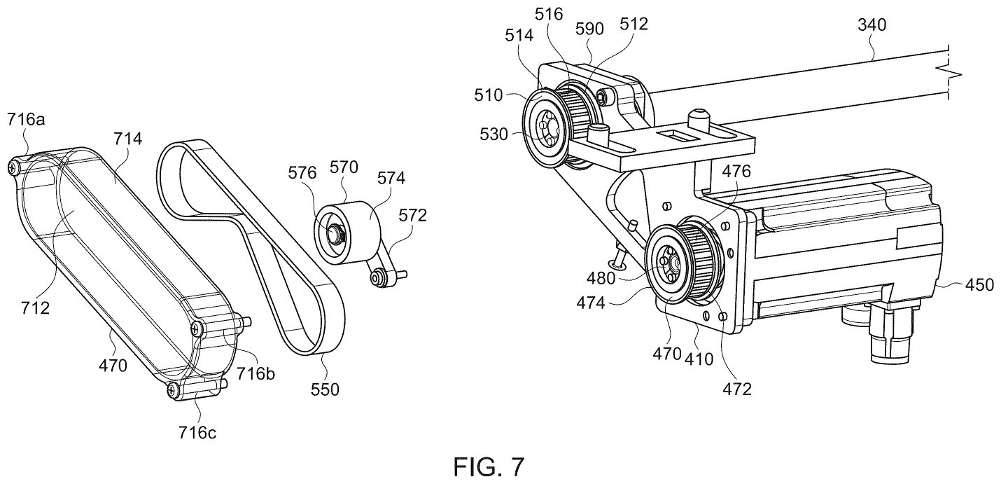

The first rotatable pulley 470 (that functions as a drive pulley) is cylindrical and includes a cylindrical inner rim 472, a cylindrical out rim 474, and a cylindrical belt engager 476 between and connecting the cylindrical inner rim 472 and the cylindrical out rim 474, as best shown in FIGS. 7, 8, and 9. The belt engager 476 includes a plurality of ribs (not labeled) that facilitate engagement with the drive belt 550. The first rotatable pulley 470 is journaled about the drive shaft 452 of the servo motor 450 and is secured thereto by the first locking assembly 490. The first rotatable pulley 470 is made from aluminum but can be made from another other material.

The first locking assembly 490 is cylindrical and sized and otherwise configured to be positioned in a central opening (not labeled) of the first rotatable pulley 470 to mount and connect the first rotatable pulley 470 to the drive shaft 452 of the server motor 450. The first locking assembly 490 and the first rotatable pulley 470 are thus mounted on the drive shaft 452 of the servo motor 450 such that: (1) rotation of the drive shaft 452 in a first rotational direction causes rotation the first rotatable pulley 470 in that first rotational direction; and (2) rotation of the drive shaft 452 in an opposite second rotational direction causes rotation the first rotatable pulley 470 in that opposite second rotational direction. The first locking assembly 490 is made from suitable metals but can be made from other materials.

The second rotatable pulley 510 (that functions as a driven pulley) is cylindrical and includes a cylindrical inner rim 512, a cylindrical out rim 514, and a cylindrical belt engager 516 between and connecting the cylindrical inner rim 512 and the cylindrical out rim 514, as best shown in FIGS. 7, 8, and 9. The belt engager 516 includes a plurality of ribs (not labeled) that facilitate engagement with the drive belt 550. The second rotatable pulley 510 is journaled about the end of the drive rod 340 and is secured thereto by the second locking assembly 530. The second rotatable pulley 510 is made from aluminum but can be made from another material.

In this example embodiment, the first rotatable pulley 470: (a) is spaced-apart from the second rotatable pulley 510; and (b) extends in a same plane as the second rotatable pulley 510 with respect to the mount 410. In this example embodiment, the axis of rotation of the first rotatable pulley 470 is off set from but parallel to the axis of rotation of the second rotatable pulley 510.

The second locking assembly 530 is cylindrical and sized and otherwise configured to be positioned in a central opening (not labeled) of the second rotatable pulley 510. Thus, the second locking assembly 530 and the second rotatably pulley 510 are mounted on the drive rod 340 such that: (1) rotation of the second rotatable pulley 510 in a first rotational direction causes rotation of the drive rod 340 in that first rotational direction; and (2) rotation of the second rotatable pulley 510 in an opposite second rotational direction causes rotation of the drive rod 340 in that opposite second rotational direction. The second locking assembly 530 is made from suitable metals but can be made from other materials.

The drive belt 550 is a continuous rubber belt in this example but can be made from another suitable material. The drive belt 550 is sized and configured to be positioned about the first drive pulley 470 and the second drive pulley 510. The drive belt 550 includes internal ribs (not shown) configured to engage the ribs of the belt engager 476 of the first drive pulley 470 and the ribs of the belt engager 516 of the second drive pulley 510. The drive belt 550 is mounted on the first drive pulley 470 and the second drive pulley 510 such that: (1) rotation of the first rotatable pulley 470 in a first rotational direction causes rotation of the drive belt 550, the second rotatable pulley 510, and the drive rod 340 in that first rotational direction; and (2) rotation of the first rotatable pulley 470 in an opposite second rotational direction causes rotation of the drive belt 550, the second rotatable pulley 510, and the drive rod 340 in that opposite second rotational direction. Thus, the drive belt 550 (and these other components) creates an indirect connection between the servo motor 450 and the drive rod 340.

The belt tensioner 570 includes a mounting bar 572 connected to the mount 410 by a fastener (not labeled) and a roller 574 freely rotatably connected to mounting bar 572 by an axle 576. The belt tensioner 570 is configured to apply tension to the drive belt 576, as best shown in FIGS. 3, 4, 6, 10, 11, 12 and 13. The belt tensioner 570 is made from suitable metals but can be any from other suitable materials.

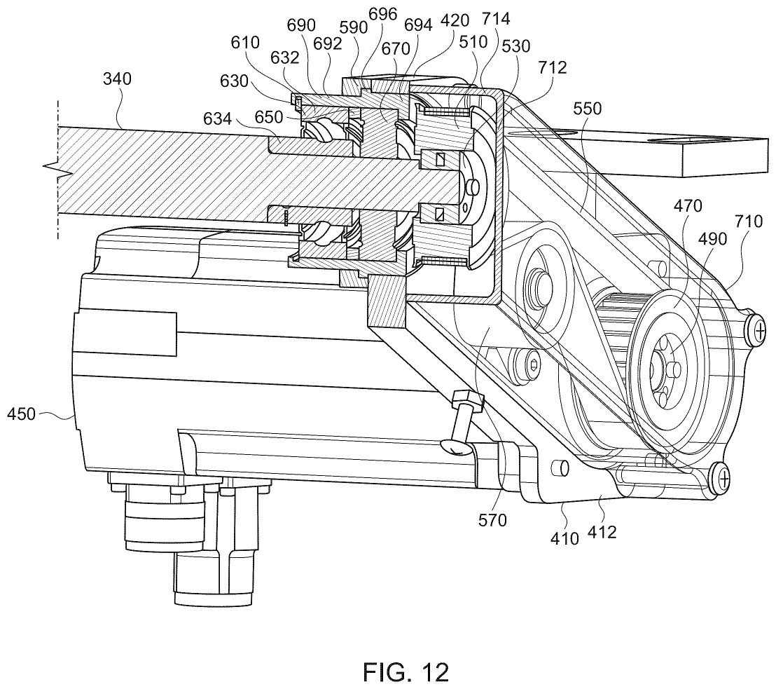

As best shown in FIG. 12, the connection plate 590, the retainer ring 610, the first bearing 630, the sleeve or spacer 650, the second bearing 670, and the bearing support sleeve 690 co-act to support end of the drive rod 340 relative to the upper section of the mount 410 and such that the second rotatable pulley 510 can rotate the drive rod 340 in either rotational direction.

More specifically, the connection plate 590 defines a central cylindrical opening (not labeled) configured to receive the drive rod 340, the retainer ring 610, the first bearing 630, and the bearing support sleeve 690. The connection plate 590 defines a plurality of openings (not all shown and not labeled) configured to receive fasteners (not shown) that connect the connection plate 590 to the upper section 422 of the mount 410. The connection plate 590 include inner surfaces (not labeled) that define an inner cylindrical lip receipt area (not labeled) configured to receive an outwardly extending lip 696 of the bearing support sleeve 690, as best shown in FIG. 12. The connection plate 590 is thus configured to hold the connection plate 590 in position, as also best shown in FIG. 12. The connection plate 590 is made from steel but can be made from another suitable material.

The retainer ring 610 is configured to engage an inner portion of the bearing support sleeve 690 and retain the sub-assembly of the bearing 630, a spacer sleeve 650, the bearing 670, the sleeve 692, and the plate 590. This enables easier installation of this this sub-assembly. The retainer ring 610 is made from a spring steel but can be made from another suitable material.

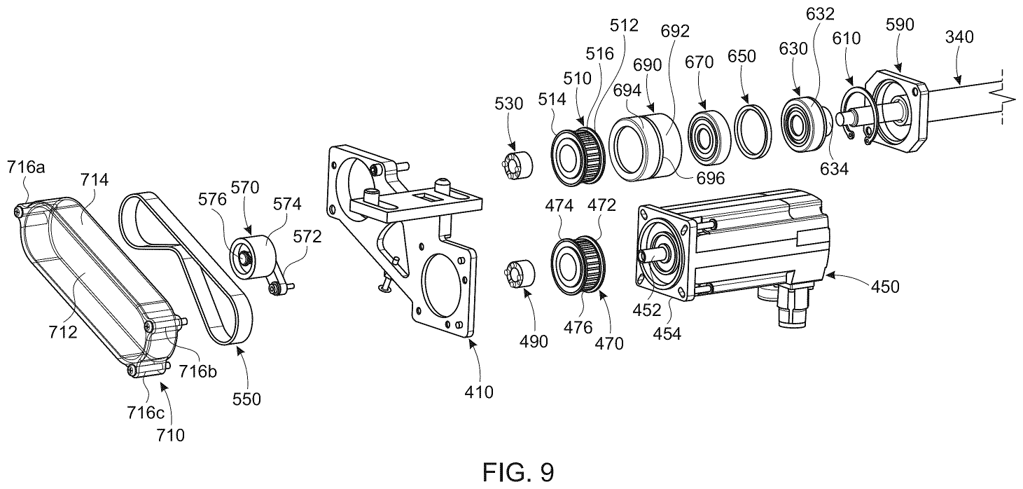

The first bearing 630 (that is or functions as a radial roller bearing) includes an outer cylindrical member 632 and an inner cylindrical member 634 as best shown in FIGS. 9 and 12. The inner cylindrical member 634 includes an inner cylindrical wall (not labeled) configured to receive and engage an outer cylindrical surface of the drive rod 340, as best shown in FIG. 12. The first bearing 630 is made from steel but can be made from another suitable material.

The spacer sleeve 650 is a cylindrical ring that separates the bearing 630 and the bearing 670, as best shown in FIGS. 9 and 12. The spacer sleeve 650 is configured to provide the space between these bearings within sleeve 690 and ensure support of the shaft 340. The spacer sleeve 650 is made from steel but can be made from another suitable material. The sleeve 690 is of a length to enable the buildup of the bearing 670, the spacer sleeve 650, the bearing 630 and the retaining ring 610. It is then packaged with plate 590 to make the installation process easier on site for an existing truss assembly table.

The second bearing 670 has an internal diameter suitably sized and configured to receive the drive rod 340, as best shown in FIG. 12. The second bearing 670 is a sealed steel roller bearing but can be made from another suitable material.

The bearing support sleeve 690 includes a first cylindrical section 692, a second cylindrical section 694, and the outwardly extending lip 696. The bearing support sleeve 690 is configured to support the drive rod 340. The lip 696 of the sleeve 690 enables the assembly to be held in place between plate 590 and the upper section 420 of the mount 410 upon installation. The bearing support sleeve 690 is made from steel but can be made from another suitable material.

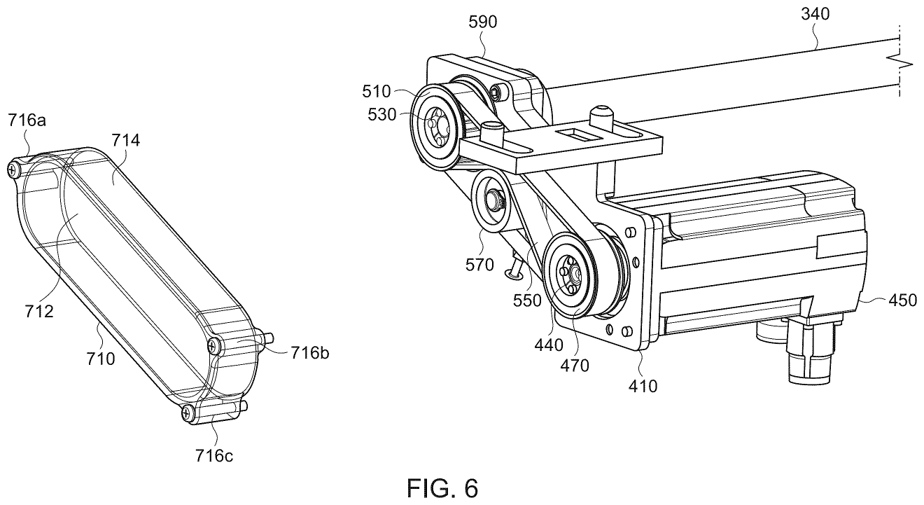

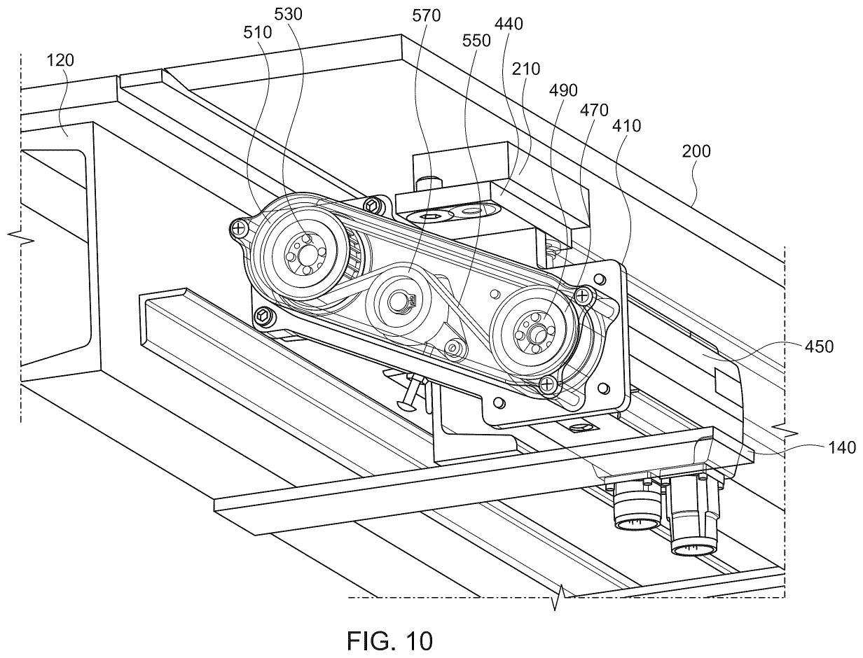

The cover 710 is attached to the mount by fasteners (not labeled), as best shown in FIGS. 10, 11, 12, and 13. The cover 710 is a single machined piece and includes an outer wall 712, an outer side wall 714 connected to the outer wall 712, and fastener mounting sleeves 716a, 716b, and 716c connected to the side wall 714, as best shown in FIGS. 6, 7, 8, and 12. The cover 710 is configured to protect: (1) part of the mount 410; (2) part of the servo motor 450; (3) the first rotatably pulley 470; (4) the first locking assembly 490; (5) the second rotatable pulley 510; (6) the second locking assembly 530; (7) the drive belt 550; (8) the belt tensioner 570; (9) the first bearing 630; (10) the sleeve 650; (11) the second bearing 670; and (12) the bearing support sleeve 690, from debris and to provide access to these components. The cover prevents an operator from being able to put their hands in contact with various covered rotating components. The cover 710 is aluminum in this example embodiment but can be made of any suitable material and otherwise configured.

As mentioned above, a new control system configured to control a servo motor that directly rotates a drive rod of a truss assembly table has been developed. Such control system is configured to cause the servo motor to rotate its drive shaft to directly rotate the drive rod of a truss assembly table: (1) in a first rotational direction to cause the drive shaft to rotate in that first rotational direction and thus to move the mounting block and puck attached to such drive shaft in a first translational direction relative to the tabletop; and (2) in an opposite second rotational direction to cause the drive shaft to rotate in that second rotational direction and thus to move the mounting block and puck attached to such drive shaft in a second translational direction relative to the tabletop.

As explained about, the present disclosure contemplates an indirect coupling of the servo motor to the drive rod. For this indirection coupling, the operation of the control system is reversed such that the control system is configured to cause the servo motor to rotate its drive shaft to indirectly rotate the drive rod of the truss assembly table: (1) in a first rotational direction to cause the drive shaft to rotate in the second rotational direction and thus to move the mounting block and puck attached to such drive shaft in a first translational direction relative to the tabletop; and (2) in an opposite second rotational direction to cause the drive shaft to rotate in the first rotational direction and thus to move the mounting block and puck attached to such drive shaft in a second translational direction relative to the tabletop.

In various embodiments, the control system (not shown) includes one or more manually controlled switching mechanisms.

In various embodiments, the control system includes one or more PLC board or is integrated into one or more PLC boards.

In various embodiments, the control system includes one or more processing devices communicatively connected to one or more memory devices.

In various embodiments, the control system includes a programmable logic control system. The processing device can include any suitable processing device such as, but not limited to, a general-purpose processor, a special-purpose processor, a digital-signal processor, one or more microprocessors, one or more microprocessors in association with a digital-signal processor core, one or more application-specific integrated circuits, one or more field-programmable gate array circuits, one or more integrated circuits, and/or a state machine.

In various embodiments, the control system includes a memory device. The memory device can include any suitable memory device such as, but not limited to, read-only memory, random-access memory, one or more digital registers, cache memory, one or more semiconductor memory devices, magnetic media such as integrated hard disks and/or removable memory, magneto-optical media, and/or optical media. The memory device stores instructions executable by the processing device to control operation of the truss assembly table 10.

In various embodiments, the control system is communicatively and operably connected to the actuators including the servo motors, the operator interface, and the power supply, and configured to receive signals from and send signals to those components.

In various embodiments, the control system is communicatively connectable (such as via Wi-Fi, Bluetooth, near-field communication, or other suitable wireless communications protocol) to an external device, such as a computing device, to send information to and receive information from that external device.

In various embodiments, the operator interface (not shown) includes a suitable display screen with a touch panel. In such embodiments with a display screen, the display screen is configured to display information regarding the truss assembly table 10, and the touch screen is configured to receive operator inputs. The operator interface is communicatively connected to the control system to send signals to the control system and to receive signals from the control system. Other embodiments of the truss assembly table 10 do not include a touch panel. Certain embodiments of the truss assembly table 10 include a separate pushbutton panel instead of a touch panel beneath or integrated with the display screen. In certain embodiments of the truss assembly table 100, the operator interface includes one or more pushbuttons (and associated light) and no display screen or touch panel.

In various embodiments, the power supply (not shown) is electrically connected to (via suitable wiring and other components) and configured to power several components of the truss assembly table 10. In various embodiments, the power supply can include a pneumatic air power supply.

In various embodiments, the gantry (not shown) includes a suitable gantry that is longitudinally moveable relative to the tabletop 200 and configured to secure attachment plates to the chord members and web members of a truss being built in a conventional manner or in a manner to be developed in the future on the truss assembly table 10.

It should be appreciated from the above that various embodiments of the present disclosure provide a truss assembly table comprising: (1) a table frame; (2) a tabletop supported by the table frame; and (3) a puck assembly including: (a) a drive rod positioned below a top surface of the tabletop, (b) a mounting block movably connected to the drive rod and positioned below the top surface of the tabletop, (c) a puck supported by the mounting block, and at least partially positioned above the top surface of the tabletop, and (d) a drive rod actuation assembly supported by the table frame and including a servo motor that is indirectly coupled to the drive rod. In various such embodiments, the servo motor is spaced-apart from the drive rod and the servo motor extends parallel to the drive rod. In various such embodiments, the servo motor is spaced-apart from the drive rod, the servo motor extends parallel to the drive rod, and the servo motor extends in a same direction as the drive rod. In various such embodiments, an axis of rotation of the servo motor is parallel to an axis of rotation of the drive rod. In various such embodiments, the servo motor is indirectly coupled to the drive rod by a drive belt. In various such embodiments, the drive rod actuation assembly includes a first pulley connected to a drive shaft of the servo motor, a second pulley connected to the drive rod, and a drive belt rotatable about the first pulley and the second pulley. In various such embodiments, the drive rod actuation assembly includes a belt tensioner configured to apply tension to the drive belt. In various such embodiments, the truss assembly table includes a mount supported by the table frame, the mount having a lower section and an upper section, the lower supporting the servo motor and the first pulley, the upper section supporting the drive rod and the second pulley. In various such embodiments, the mount is connected to the tabletop such that the upper section of the mount is closer to the tabletop than the lower section of the mount.

It should further be appreciated from the above that various embodiments of the present disclosure provide a truss assembly table retrofit assembly for a truss assembly table including a table frame, a tabletop supported by the table frame, and a puck assembly including a drive rod positioned below a top surface of the tabletop, wherein the truss assembly table retrofit assembly comprises: (1) a mount supported by the table frame; and (2) a servo motor supportable by the mount and indirectly couplable to the drive rod such that the servo motor is spaced-apart from the drive rod and the servo motor extends parallel to the drive rod. In various such embodiments, the mount is configured to support the servo motor in a position that is spaced-apart from the drive rod and that extends parallel to the drive rod. In various such embodiments, the mount is configured to support the servo motor in a position that is spaced-apart from the drive rod, which is parallel to the drive rod, and that extends in a same direction as the drive rod. In various such embodiments, the mount is configured to support the servo motor in a position such that an axis of rotation of the servo motor is parallel to an axis of rotation of the drive rod. In various such embodiments, the truss assembly table retrofit assembly includes a drive belt configured to indirectly couple the servo motor to the drive rod. In various such embodiments, the truss assembly table retrofit assembly includes a first pulley connectable to a drive shaft of the servo motor, a second pulley connectable to the drive rod, and a drive belt rotatable about the first pulley and the second pulley. In various such embodiments, the truss assembly table retrofit assembly includes a belt tensioner configured to apply tension to the drive belt to prevent slippage of the drive belt. In various such embodiments, the mount has a lower section and an upper section, the lower configured to support the servo motor and the first pulley, the upper section configured to support the drive rod and the second pulley. In various such embodiments, the mount is connectable to the tabletop such that the upper section of the mount is closer to the tabletop than the lower section of the mount.

It should further be appreciated that various embodiments of the present disclosure provide a truss assembly table retrofit assembly for a truss assembly table where the servo motor is supportable by the mount in a different direction than described above such as in a position transverse (such as perpendicular) to the drive rod. In such alternative embodiments, the indirect coupling of the drive rod to the servo motor is via co-acting gears such as 45-degree gears or another suitable manner.

It will be understood that modifications and variations may be affected without departing from the scope of the novel concepts of the present invention, and it is understood that this application is to be limited only by the scope of the claims.

1. A truss assembly table comprising:
a table frame;
a tabletop supported by the table frame; and
a puck assembly including:
a drive rod positioned below a top surface of the tabletop,
a mounting block movably connected to the drive rod and positioned below the top surface of the tabletop,
a puck supported by the mounting block, and at least partially positioned above the top surface of the tabletop, and
a drive rod actuation assembly supported by the table frame and including a servo motor that is indirectly coupled to the drive rod.

2. The truss assembly table of claim 1, wherein the servo motor is spaced-apart from the drive rod and the servo motor extends parallel to the drive rod.

3. The truss assembly table of claim 1, wherein the servo motor is spaced-apart from the drive rod, the servo motor extends parallel to the drive rod, and the servo motor extends in a same direction as the drive rod.

4. The truss assembly table of claim 1, wherein an axis of rotation of the servo motor is parallel to an axis of rotation of the drive rod.

5. The truss assembly table of claim 1, wherein the servo motor is indirectly coupled to the drive rod by a drive belt.

6. The truss assembly table of claim 1, wherein the drive rod actuation assembly includes a first pulley connected to a drive shaft of the servo motor, a second pulley connected to the drive rod, and a drive belt rotatable about the first pulley and the second pulley.

7. The truss assembly table of claim 6, wherein the drive rod actuation assembly includes a belt tensioner configured to apply tension to the drive belt.

8. The truss assembly table of claim 6, which includes a mount supported by the table frame, the mount having a lower section and an upper section, the lower supporting the servo motor and the first pulley, the upper section supporting the drive rod and the second pulley.

9. The truss assembly table of claim 8, wherein the mount is connected to the tabletop such that the upper section of the mount is closer to the tabletop than the lower section of the mount.

10. A truss assembly table retrofit assembly for a truss assembly table including a table frame, a tabletop supported by the table frame, and a puck assembly including a drive rod positioned below a top surface of the tabletop, the truss assembly table retrofit assembly comprising:
a mount supported by the table frame; and
a servo motor supportable by the mount and indirectly couplable to the drive rod such that the servo motor is spaced-apart from the drive rod and the servo motor extends parallel to the drive rod.

11. The truss assembly table retrofit assembly of claim 10, wherein the mount is configured to support the servo motor in a position that is spaced-apart from the drive rod and that extends parallel to the drive rod.

12. The truss assembly table retrofit assembly of claim 10, wherein the mount is configured to support the servo motor in a position that is spaced-apart from the drive rod, which is parallel to the drive rod, and that extends in a same direction as the drive rod.

13. The truss assembly table retrofit assembly of claim 10, wherein the mount is configured to support the servo motor in a position such that an axis of rotation of the servo motor is parallel to an axis of rotation of the drive rod.

14. The truss assembly table retrofit assembly of claim 10, which includes a drive belt configured to indirectly couple the servo motor to the drive rod.

15. The truss assembly table retrofit assembly of claim 10, which includes a first pulley connectable to a drive shaft of the servo motor, a second pulley connectable to the drive rod, and a drive belt rotatable about the first pulley and the second pulley.

16. The truss assembly table retrofit assembly of claim 15, which includes a belt tensioner configured to apply tension to the drive belt to prevent slippage of the drive belt.

17. The truss assembly table retrofit assembly of claim 15, wherein the mount has a lower section and an upper section, the lower configured to support the servo motor and the first pulley, the upper section configured to support the drive rod and the second pulley.

18. The truss assembly table retrofit assembly of claim 17, wherein the mount is connectable to the tabletop such that the upper section of the mount is closer to the tabletop than the lower section of the mount.
